(19) United States
(12) Patent Application Publication
(10) Pub. No.: US 2017/0327693 A1
(43) Pub. Date: Nov. 16, 2017

(54) IN VACUO COATING COMPOSITIONS

(71) Applicant: Camvac Limited, Norfolk (GB)

(72) Inventors: James Tiw SHIPMAN, Norfolk (GB); Adeola Babatunde JULIUS, Norfolk (GB)

(21) Appl. No.: 15/585,387

(22) Filed: May 3, 2017

(30) Foreign Application Priority Data
May 12, 2016 (GB) 1608312.3

(51) Int. Cl. C09D 4/00; C09D 7/12; B05D 3/00

(52) U.S. Cl. CPC C09D 4/00; B05D 3/007; C09D 7/1233

(57) ABSTRACT

The invention relates to the use of a composition for in vacuo coating of a substrate, the composition comprising: at least 50% by weight an acrylate monomer or an oligomer formed from the acrylate monomer, the acrylate monomer having the formula H2C═CHCO2CH2CH(OH)R, where R is an optionally substituted alkyl, alkenyl, aryl, or heteroaryl; and 0.5 to 15% by weight an adhesion promoter. The present invention also related to uses of the composition and methods of coating a substrate in vacuo using the composition.

### RELATED APPLICATIONS

This application claims priority from United Kingdom Application Serial No. GB 1608312.3 filed May 12, 2016, the entire disclosure of which is incorporated herein by this reference.

### BACKGROUND TO THE INVENTION

Films having enhanced barrier properties for oxygen or other gases or odours or water vapour are produced by depositing alternate layers of cured polymer and metal or compounds onto a web substrate using processes such as vacuum deposition. These films are useful for packaging of oxygen or moisture sensitive foodstuffs, encapsulation of gas or moisture sensitive components, and a variety of other functional applications requiring barrier properties.

It is known to deposit layers of cured polymer onto a web substrate using vacuum deposition. In particular, a radiation curable precursor is flash vaporised and then deposited on to a moving substrate, where it is cured, for example by plasma, ion beam, or UV, either concurrently to deposition or sequentially after deposition. WO2014/118513 gives details of apparatus and methods that can be used to deposit and cure the radiation curable precursor. Acrylates have been used in the past as the radiation curable precursor. WO2014/118513 discloses that the radiation curable precursor is preferably tripropylene glycol diacrylate or isobornyl acrylate.

However, known processes of vacuum condensation and curing of polymer precursors have a number of drawbacks and risks. It is known that the acrylate condensate can re-evaporate before reaching the curing zone. This vapour can then potentially contaminate the pumps, or become entrained with the moving web, re-condense on the surface of the cured coating as an uncured, and therefore weak, surface layer (giving poor adhesion of any subsequent coatings applied to the material). This means that, using prior art acrylate compositions, excessive cleaning of the apparatus is needed. Indeed, in the prior art, the run time of the apparatus and flow rates of the acrylate is usually limited by the composition.

Additionally, many prior art polymer precursors produce polymer coatings where adhesion issues are a result of one or more of the following: polymer coatings failing to adhere sufficiently to substrates; polymer coatings failing to adhere to other metal or oxide coatings used in the production of a final structure; metal or oxide coatings failing to adhere to the polymer coatings; and poor cohesion of the polymer coatings meaning the coating itself can separate in the final structure. This is typically the case even when adhesion promoters are added into the monomer compositions. Prior art acrylate coatings therefore typically fail to show the required adhesion characteristics of >150 g/25 mm ideally >300 g/25 mm. Prior art acrylate coatings especially fail to combine the required adhesion qualities with the barrier improvements desired for Oxygen and Moisture barrier materials.

Further concerns that have arisen with prior art acrylates compositions include that they have an unpleasant odour, which is unappealing for consumers. The prior art acrylates may not adhere well to the substrate or to an inorganic layer. Furthermore, the prior art acrylate compositions often contain a number of inherent impurities that are not very well suited for use in food contact applications.

For the reasons give above, there is a need in the art to improve the polymers precursor compositions for deposition in vacuo.

### SUMMARY OF THE INVENTION

According to a first aspect, the present invention relates to a composition or the use of a composition for in vacuo coating of a substrate, the composition comprising:
at least 50% by weight of the composition an acrylate monomer or an oligomer formed from the acrylate monomer, the acrylate monomer having the formula H2C═CHCO2CH2CH(OH)R, where R is an optionally substituted alkyl, alkenyl, aryl, or heteroaryl; and
0.5 to 15% by weight of the composition an adhesion promoter.

According to a second aspect, the present invention relates to a method of coating a substrate in vacuo, the method comprising the steps of:
providing a composition according to the first aspect of the invention;
depositing the composition onto a substrate in vacuo; and
curing the composition.

According to a third aspect, the present invention relates to a film, the film comprising a substrate which is coated on at least one surface with a polymeric coating, wherein film is obtainable by the method according to the second aspect of the invention. The film can optionally be already coated with other coatings, applied either in line with the polymeric coating, or applied in a separate process prior to the polymeric coating process.

The present invention relates to the use of compositions for the in vacuo coating of a substrate, as well as to a method of coating a substrate, and a film comprising a coating and a substrate. In vacuo coating processes are known, as set out in the Background to the Invention section, above, and involve depositing a composition onto a substrate and then curing the composition in vacuo. By in vacuo we mean lower than atmospheric pressure, normally lower than 1.5 mbar. A typical vacuum pressure used is below 1 mbar, preferably below 0.5 mbar.

Prior compositions typically comprise di functional, tri functional or tetra functional acrylate monomers. It has surprisingly been discovered that sufficient cross linking to form a polymer coating with the required adhesion and barrier improvement properties can be achieved using a composition comprising 50% or greater of a monofunctional epoxy acrylate monomer or an oligomer formed from the monofunctional epoxy acrylate monomer. The resultant coatings have sufficient cross linking to form continuous cured coating and achieve the required barrier gains, but are soft and elastic enough to achieve good adhesive/cohesive qualities required in final applications such as, but not limited to: laminates to other flexible webs for a number of uses including but not limited to: lidding films; dry food packages; retort packages or films; liquid packaging; medical packaging; barrier materials for photovoltaic (PV) applications; vacuum insulation panels (VIP); insulation products and others. Many of these have specific challenges requiring very good adhesive/cohesive strength of the laminates. These include, but are not limited to: lidding films, which should not delaminate when the film is removed and thus there is a need for good adhesive/cohesive strength across all layers within the structure; liquid packaging, where laminates should demonstrate good burst and drop performance which may not be possible unless all layers within the construction show excellent adhesion/cohesion; retort packages, where the films and barrier may be expected to survive elevated temperatures, typically 120° C., and humidity for hours (typically 2-3 hours); VIP envelopes, where a high vacuum is applied to the inside of the envelope causing considerable stresses and forces within the barrier envelope material which without good adhesion/cohesion of the acrylate layer or layers would result in delamination and loss of the barrier; and PV applications, where the products must remain bonded together after many years in the outdoor environment.

Insulation materials where the acrylate may need to survive atmospheric attack over many years (typically >20) without delaminating from the substrate. Many prior art compositions for in vacuo deposition include a substantial isobornyl acrylate component. This is typically responsible for crosslinking in the cured acrylate polymer. It has surprisingly been found by the inventors that, instead of a crosslinking monomer like isobornyl acetate, an acrylate monomer or oligomer according to the present invention can be used in conjunction with a small amount of adhesion promoter to advantageous effect. In particular, a composition according to the present invention surprisingly performs just as well as, if not better than, prior art compositions, while avoiding many of the problems associated with prior art compositions. In particular, the composition of the present invention enables good adhesion values to be obtained, especially for films that are metallised or otherwise coated with barrier layers by methods known by those skilled in the art.

In more detail, compositions according to the present invention when deposited and cured can exhibit: good adhesion to a range of polymer webs, including orientated polypropylene (OPP) and polyethylene terephthalate (PET); good adhesion to metal layers such as aluminium (Al) and aluminium oxide (AlOx) which can be deposited by metallisation on top of or underneath the polymer layer; good cohesion in a thin film within a final barrier web, good wetting characteristics; good barrier properties; and an appropriate flexibility. Despite not containing the substantial levels of crosslinker monomer as in the prior art the composition of the present invention, when cured, can still produce sufficient cross linking to enable the polymer coating layer to be used as a planarising layer below a metal (Met) or AlOx layer, as a top coat of Met or AlOx coated substrate, or as an interlayer between two Met or AlOx layers. The metal layer is typically Al but other metals such as Cu, Ag, Fe, and Ti etc. can be used. The composition of the invention can also be used to provide excellent adhesion to inorganic barrier layers and to oxides other than AlOx, such as SiOx and ITO (Indium Tin Oxide).

Compositions according to the present invention have several advantages over prior art precursor compositions including reduced odours and reduced fouling of cure equipment which means that increased flow rates can be used and/or thicker layers deposited. Adhesion is also improved, especially for metallised films. The lower power density utilised for curing reduces the wear and heat damage on the substrate. In addition, several potentially harmful impurities associated with the prior art compositions are not associated with the present invention composition, which means that it is better suited to use in food contact applications.

In the prior art isobornyl acrylate, tripropylene glycol diacrylate (TPGDA) or similar was often used but has the disadvantage of not providing optimal adhesion to the substrate and/or metal. In particular, with TPGDA adhesion of metal coated over the TPGDA is <150 g/25 mm typically <50 g/25 mm. With compositions according to the present invention, adhesion of >300 g/25 mm and often even >500 g/25 mm can be achieved. In addition, compositions of the present invention allow metallisation of substrates that typically show poorer Met adhesion e.g. OPPs, CPPs and others such as Cellulose Acetate. Again with such substrates this allows the adhesion of the metal to be increased from <150 g/25 mm (often much lower) to >300 g/25 mm.

In the present invention a composition is used that comprises more than 50% of an acrylate monomer having the general formula H2C═CHCO2CH2CH(OH)R, where R is an optionally substituted alkyl, alkenyl, aryl, or heteroaryl.

In graphic form, the composition of the present invention comprises more than 50% by weight of a compound of formula I.

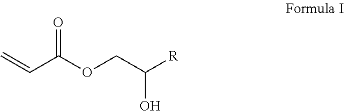

where R is an optionally substituted alkyl, alkenyl, aryl, or heteroaryl.

Alternatively, the composition comprises an oligomer formed from the monomer defined above. This is usually a short chain oligomer, having 2 to 10, or most often just 2 or 3 monomers.

In one embodiment, R is an alkyl. “Alkyl” refers to a straight or branched hydrocarbon chain radical consisting solely of carbon and hydrogen atoms, containing no unsaturation, having from one to twelve carbon atoms, preferably one to eight carbon atoms or one to six carbon atoms and which is attached to the rest of the molecule by a single bond, for example, methyl, ethyl, n-propyl, 1-methylethyl (iso-propyl), n-butyl, n-pentyl, 1,1-dimethylethyl (t-butyl), 3-methylhexyl, 2-methylhexyl, and the like. For purposes of this invention, the term “lower alkyl” refers to an alkyl radical having one to six carbon atoms.

“Optionally substituted alkyl” refers to an alkyl radical, as defined above, which is optionally substituted by one or more substituents selected from the group consisting of halo, cyano, nitro, oxo, thioxo, trimethylsilanyl, —OR¹, —OC(O)—R¹, —N(R¹)2, —C(O) R¹, —C(O)O R¹, or —C(O)N(R¹)2, where each R¹ is independently selected from the group consisting of hydrogen, alkyl, haloalkyl, optionally substituted cycloalkyl, optionally substituted aryl, and optionally substituted heteroaryl. In a preferred embodiment, R is a lower alkyl substituted with —OR¹ where R¹ is phenyl, for example R is phenyl methyl ether, phenyl ethyl ether, or phenyl propyl ether.

In one embodiment, R is an alkenyl. “Alkenyl” refers to a straight or branched hydrocarbon chain radical consisting solely of carbon and hydrogen atoms, containing at least one double bond, having from two to twelve carbon atoms, preferably one to eight or one to six carbon atoms and which is attached to the rest of the molecule by a single bond, for example, ethenyl, prop-1-enyl, but-1-enyl, pent-1-enyl, penta-1,4-dienyl, and the like.

“Optionally substituted alkenyl” refers to an alkenyl radical, as defined above, which is optionally substituted by one or more substituents selected from the group consisting of halo, cyano, nitro, oxo, thioxo, trimethylsilanyl, —O R¹, —OC(O)—R¹, —N(R R¹)2, —C(O) R¹, —C(O)O R¹, or —C(O)N(R¹)2, where each R¹ is independently selected from the group consisting of hydrogen, alkyl, haloalkyl, optionally substituted cycloalkyl, optionally substituted aryl, and optionally substituted heteroaryl.

In one embodiment, R is an aryl. “Aryl” refers to a hydrocarbon ring system radical comprising hydrogen, 6 to 14 carbon atoms and at least one aromatic ring. The aryl radical is usually monocyclic, but may be bicyclic. An aryl radical is commonly, but not necessarily, attached to the parent molecule via an aromatic ring of the aryl radical. Aryl radicals include, but are not limited to, aryl radicals derived from acenaphthylene, anthracene, azulene, benzene, naphthalene, phenalene, and phenanthrene. Preferably the aryl radical is derived from benzene, such as is phenyl.

“Optionally substituted aryl” refers to an aryl radical, as defined above, which is optionally substituted by one or more substituents selected from the group consisting of alkyl, alkenyl, alkynyl, halo, haloalkyl, haloalkenyl, haloalkynyl, cyano, or nitro.

In one embodiment, R is a heteroaryl. The term “heteroaryl” means a monocyclic- or polycyclic aromatic ring comprising 3 to 14 carbon atoms, hydrogen atoms, and one or more heteroatoms, preferably, 1 to 3 heteroatoms, independently selected from nitrogen, oxygen, and sulphur. As is well known to those skilled in the art, heteroaryl rings have less aromatic character than their all-carbon counter parts. Thus, for the purposes of the invention, a heteroaryl group need only have some degree of aromatic character. Illustrative examples of heteroaryl groups include, but are not limited to, pyridinyl, pyridazinyl, pyrimidyl, pyrazyl, triazinyl, pyrrolyl, pyrazolyl, imidazolyl, (1,2,3)- and (1,2,4)-triazolyl, pyrazinyl, pyrimidinyl, tetrazolyl, furyl, thienyl, isoxazolyl, thiazolyl, phenyl, isoxazolyl, and oxazolyl.

“Optionally substituted heteroaryl” refers to a heteroaryl radical, as defined above, which is optionally substituted by one or more substituents selected from the group consisting of alkyl, alkenyl, alkynyl, halo, haloalkyl, haloalkenyl, haloalkynyl, cyano, or nitro. As used herein: “cyano” refers to the CN radical; “nitro” refers to the NO2 radical; “Oxo” refers to the ═O radical and “Thioxo” refers to the ═S radical.

Suitable monomers and oligomers are commercially available.

In the present invention at least half of the composition is an acrylate as defined above, preferably wherein the R group is alkyl or substituted alkyl, preferably a lower alkyl or substituted lower alkyl. Other acrylates can be present in the composition, at lower levels, but it is preferred that the composition comprises at least 60%, 70%, 80% or even 90% of the acrylate monomer or oligomer as defined above. In a preferred embodiment of the invention, the composition does not comprise isobornyl acrylate or tripropylene glycol diacrylate, which are commonly used in prior art compositions. It is preferred that the composition of the present invention consists of (i.e. does not includes components other than) the acrylate monomer or an oligomer formed from the acrylate monomer as defined above, and 0.5 to 15% by weight of the composition an adhesion promoter.

The adhesion promoter is used at a level of 0.5 to 15%, preferably 1 to 15% by weight of the composition, more preferably 2 to 10% by weight of the composition. It is used to help the oligomer bind to the substrate.

Suitable adhesion promoters are known to the skilled person and commercially available. For example, the adhesion promoter may comprise an acid modified methacrylate. A preferred acid modified methacrylate for use as the adhesion promoter is 2-hydroxyethyl methacrylate phosphate. Ethoxylated esters of acrylic acid, for example ethoxylated trimethylolpropane triacrylate or 2-(2-Ethoxyethoxy)ethyl acrylate can also be used within the adhesion promoter. The acid modified methacrylate can be used in combination with an ethoxylated esters of acrylic acid and/or phosphoric acid.

In a preferred embodiment, the adhesion promoter comprises 45 to 55% by weight 2-hydroxyethyl methacrylate phosphate and 45 to 55% by weight ethoxylated trimethylolpropane triacrylate.

In another embodiment, the adhesion promoter comprises 25 to 75% by weight of 2-hydroxyethyl methacrylate phosphate and 25 to 75% by weight 2-(2-Ethoxyethoxy)ethyl acrylate.

The adhesion promoter can comprise at least 95% by weight and up to 100% acid modified methacrylate.

The composition of the present invention is preferably suitable for deposition by flash vaporisation at up to 300° C. Practically this means that the composition has a boiling point of less than 250° C. at 1 mbar pressure.

The composition of the present invention can preferably be cured using a typical gas plasma, or a low energy (<300 eV) gas plasma.

In the second aspect of the invention, a composition according to the first aspect of the invention is used in a method of coating a substrate in vacuo, the method comprising the steps of: providing the composition according to the first aspect of the invention, depositing the composition onto a substrate; and curing the composition.

The present invention also relates to films that are obtainable though the use of the composition of the present invention to coat a substrate. The resulting films can be used for packaging, especially to provide barriers to protect moisture or gas sensitive products, or can be used as insulation or in insulation products or other applications where gas and/or moisture barriers are required.

In one embodiment of the invention, the substrate is a polymer web, such as orientated polypropylene (OPP) or polyethylene terephthalate (PET), and others discussed below. The polymer web can be coated with a metal layer, such as aluminium (Al) or aluminium oxide (AlOx) which can be deposited by metallisation. A metal layer can instead or in addition be later deposited on top of the coating of the present invention, as discussed below. The substrate is normally moving when the composition is deposited onto it, for example in a reel to reel process.

The composition can be deposited onto the substrate in any conventional way, such as by a stream of monomer/oligomer vapour exiting the nozzle and depositing on the web as shown in the figures and discussed below.

The composition can be cured in any conventional way, including by ion beam or UV curing as well as plasma curing. The curing has the effect of polymerising the acrylate monomer or oligomer. Preferably the composition is cured with a plasma with an ion flux having an energy level between 3.6 eV and 250 eV.

Further details of the methods that can be used are shown in the figures, and described below.

### DESCRIPTION OF THE DRAWINGS

By way of example only, certain embodiments of the invention will now be described by reference to the accompanying drawings, in which:

FIG. 1 is a schematic drawing of apparatus for carrying out a process in which the composition of the invention can be used;

FIG. 2 is a schematic drawing of apparatus for carrying out a process in which the composition of the invention can be used;

FIG. 3 is a schematic drawing that illustrates radiation and vapour flows;

FIG. 4 is a schematic drawing showing configuration for sequential delivery and cure;

FIG. 5 is a schematic drawing showing a further configuration for sequential delivery and cure; and

FIG. 6 is a schematic drawing of apparatus according to a further embodiment of the invention.

### EMBODIMENTS OF THE INVENTION

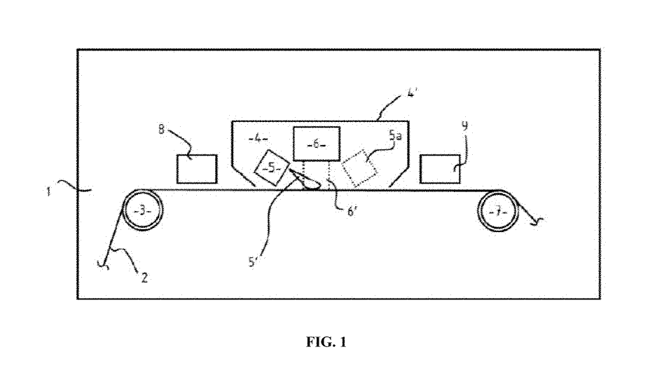

The apparatus in FIG. 1 is housed in a vacuum chamber 1. A web 2 to be treated is fed over idle rollers 3, 7 between web unwind and rewind stations (not shown). The web is fed past a deposition station 4 defined by an enclosure 4′ in which is housed a device 5 that generates a directional beam 5′ of a radiation curable material, and a low pressure gas plasma source 6 that generates a directed ion flux or alternatively an electron flux 6′. In the present invention the radiation curable material is the composition according to the first aspect of the invention in the form of a vaporised or atomised liquid.

The flux 6′ may comprise cations and other positively charged or non-charged particles and species. Alternatively, the flux may comprise electrons and non-charged particles and species. Thus, depending on the set up, either positively charged ions or electrons will be directed at the film to form the primary curing or processing initiator. The ionisation fraction of the plasma might typically be 10⁻⁵ to 10⁻¹. The beam of radiation curable material is directed at the web 2 as it passes below device 5, and the plasma source 6 simultaneously directs the ion flux 6′ at the web 2 to be incident on the web generally concurrently with the beam 5′. The beam 5′ and flux 6′ overlap so that the overlap region is exposed to the ion radiation during delivery, thereby to initiate curing as the vapour is delivered to the web 2. The enclosure 4′ serves to support a differential pressure between the inside of the enclosure and the vacuum chamber 1 so as to control escape of the precursor vapour and process gases outside of the enclosure. The apparatus can optionally have surface treatment stations 8 and 9 to enhance the properties of the web prior to and after the deposition station 4.

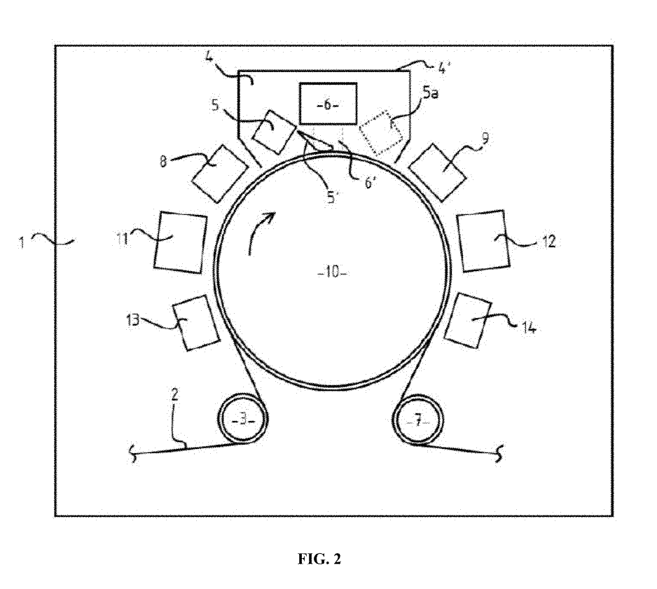

An alternative embodiment of the invention is illustrated in FIG. 2 in which the linear feed of the web 2 between rollers 3, 7 is supplemented by a rotating drum feed 10. The rotating drum 10 allows additional treatment processes to take place, e.g., further depositing stations 11, 12 for coating metallic or non-metallic compounds before and after the deposition station 4, and treatment stations 13, 14 to enhance the properties of the film before and after the optional depositing stations 11 and 12.

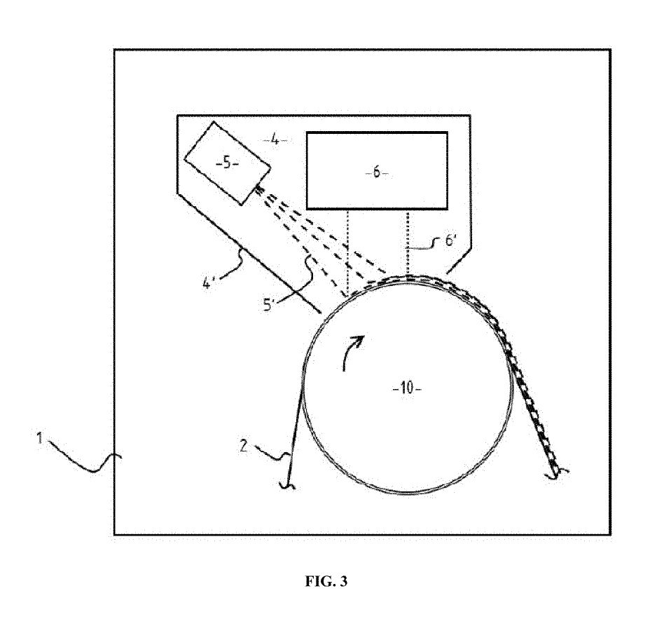

As shown in FIGS. 1 and 2, the radiation curable material deposition device 5 may be relocated to 5a, which indicates an alternative spatial configuration for delivery relative to the radiation source 6 so that it is downstream rather than upstream of the radiation 6 in the movement of the web 2. However, the precursor beam 5′ would still be angled to overlap the ion flux 6′ in a similar manner shown in FIG. 3. This shows the pattern of the precursor beam 5′ and ion flux 6′, and how these beams overlap in space and are incident concurrently on the web 2 so that a coating is progressively deposited and cured as the web passes the deposition station 4. Such an overlapping configuration may be used in embodiments of the invention.

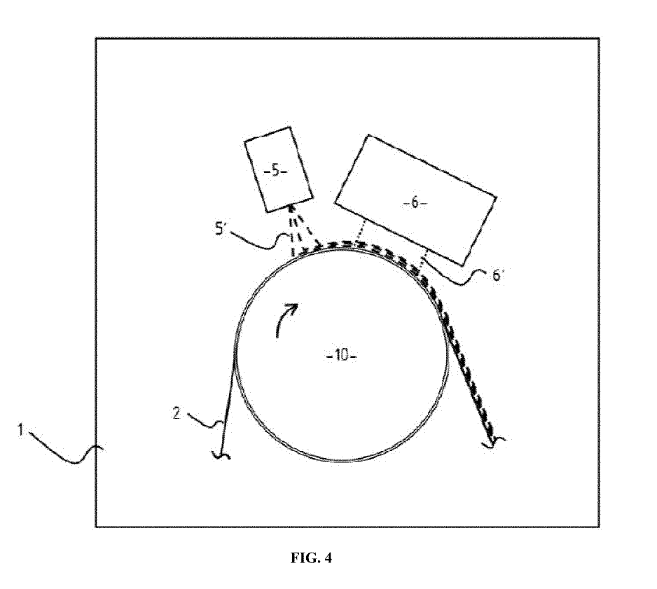

FIG. 4 shows an embodiment of the invention in which the deposition device 5 has been repositioned away from the ion flux source 6. In FIGS. 1 to 3, the deposition and curing occurs concurrently in space and time onto the web 2, whereas in the illustrated embodiment, the web 2 first passes the deposition beam 5′ and transports the uncured deposited material to the ion or electron flux 6′ to be cured. Although the deposition device 5 and ion flux source 6 are active concurrently in time, they are acting sequentially upon the web 2, and so the respective beams 5′ and 6′ are not spatially concurrent.

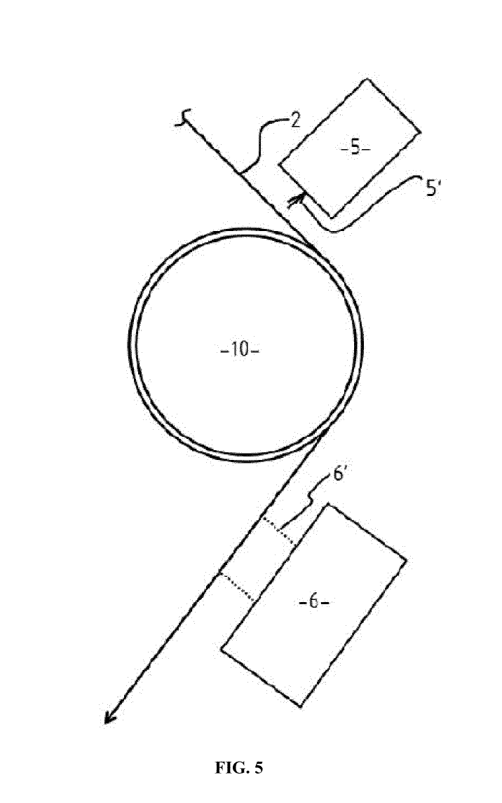

FIG. 5 shows a further embodiment of the invention in which the deposition device 5 is repositioned to deliver the vapour stream 5′ onto a free span portion of the moving web 2. The ion flux source 6 is arranged to cure in a free span position after a roller 10.

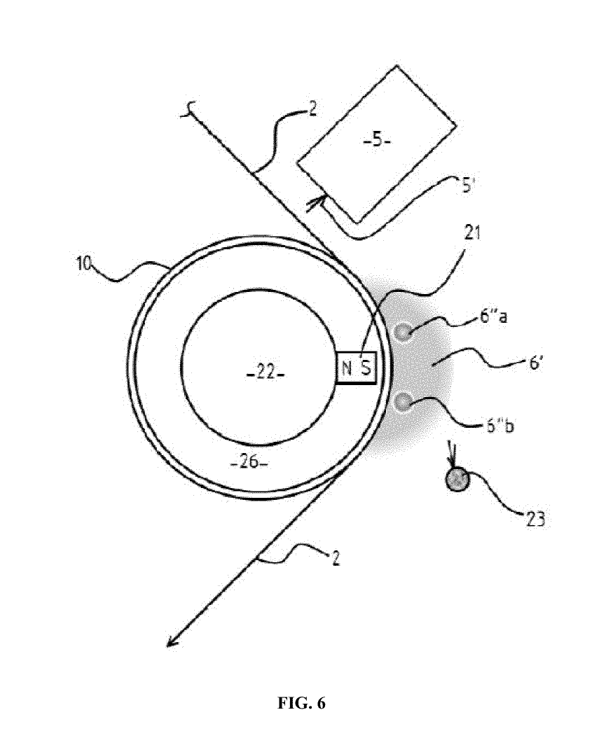

FIG. 6 shows an embodiment of the invention in which the rotating drum 10 defines a cathode arranged to attract the ion flux 6′ towards the web 2. The system is housed in a vacuum chamber (not shown). The housing enables the operating pressure to be set to an appropriate level observed to be ranging between 10-4 and 10-0 millibar (mbar), but preferentially ranging between 10-3 and 10-1 milibar (mbar). The housing may also define an anode for the generation of plasma between the anode and the cathodic drum 10. The plasma is formed from a gas, such as Argon, supplied via a gas inlet 23. As with the embodiments illustrated in FIGS. 4 and 5, the precursor is applied to the web 2 upstream with respect to the curing zone by a device 5 that generates a directional beam 5′ of a radiation curable material.

The drum 10 has an interior space 26, which may be water cooled. The drum 10 is rotatably mounted on a stationary yoke 22 disposed within the interior space 26. The stationary yoke 22 supports a magnet array 21. The magnet array 21 is arranged to produce closed loop magnetic flux lines that interact with the ion flux 6′ to define relatively narrow ‘race track’ of high density ion flux having portions 6″a, 6″b that are located in close proximity to the web 2. The inventors have discovered that the position of the magnet relative to the outer surface of the drum 10 affects the configuration, in including the separation, of the discrete race track portions. Generally speaking, the discrete race track portions are relative close together when the magnet is relatively close to the drum surface, and relative widely spaced when the magnet is located away from the drum surface, closer to the central axis of the drum.

In the illustrated embodiment, the web 2 shields the cathode roller 10 from the ion flux 6′; this is advantageous because it inhibits oxidisation and fouling of the cathode 10. In such embodiments, the radiation source 6 should be powered by an AC supply, preferably operating within the radio frequency (RF) range; for example, 40-320 kHz. In some embodiments the voltage source may be an AC source having any suitable frequency, such as 50 Hz.

Embodiments of the invention having a magnet array 21 disposed within the drum cavity 26 as in FIG. 6, can use any suitable means of plasma curing i.e. these embodiments are not limited to using an ion flux having an energy level between 3.6 eV and 250 eV for curing and/or processing.

The other embodiments of the invention provide a low energy ion flux that can be used for curing or processing steps. An advantage to using an ion flux having an energy level between 3.6 eV and 250 eV for the curing, rather than an electron flux having an energy level between 6.5 eV and 300 eV, is that any overspray of radiation curable material or re-evaporate thereof will also be cured due to species generated at earthed surfaces inside the process chamber.

As set out above, the radiation curable precursor is composition at least 50% by weight an acrylate monomer or oligomer as defined above and 0.5 to 15% by weight an adhesion promoter.

The thickness of the precursor film (also called the substrate) or the cured polymer coating can be any suitable value. For example, in some embodiments the value may be at least 0.001 μm. In some embodiments, the value is in the range 0.001 μm-50 μm, and preferably 0.01 μm to 1 μm, the preferred thickness largely being decided on the basis of the function of the polymer layer (i.e. the cured composition of the present invention) in the intended application, and cost constraints, rather than constraints arising from the process. For example, for barrier packaging applications, the function of the polymer layer may be to protect the barrier coating (i.e. the aluminium or aluminium oxide) against physical damage or abrasion. In this case, the lower limit of thickness of the polymer layer may be around 0.02 μm, as below this there is insufficient protection. The upper limit may be subjective, as above about 1 μm, the benefit of mechanical protection will begin to be outweighed by the risk of delamination.

Any web substrate which can be handled by the equipment can be used in the invention. Substrates can include a wide variety of commercially available thermoplastic films (including polyesters such as polyethylene terephthalate (PET) or polyethylene naphthalate (PEN) or blends or coextrusions thereof), polyamides (including nylon 6 and nylon 6.6), polyolefines (including polypropylene and high and low density polyethylene) and other thermoplastic films known in the art. Non-thermoplastic films, including biodegradable films and films derived from renewable resources, such as polylactic acid or cellulose-based materials including cellulose diacetate, also known as cellulose acetate, may also be used. Thermoset polymer films, such as polyimides may also be used. Fibrous, non-woven or woven substrates (such as paper or textiles) may also be used. The invention is not limited by this list of web substrates.

The process of embodiments of the invention may be a “high speed process”, meaning that the web substrate is moving at a speed of at least 50 m/min. It is preferred that the web is moving at a speed of at least 5 m/s, and more preferably that that the web is moving at a speed of at least 7 m/s. In some embodiments of the invention, the web may form part of a reel to reel process. Alternatively, for other applications the web substrate can be moving much more slowly, for example at less than 1 m/min, or 0.1 to 0.4 m/min.

Embodiments of the invention may use any easily ionisable inert gases to generate the plasma; for example argon, helium and neon, or other non-reactive gases or reactive gases including nitrogen or oxygen. Combinations of gases could be used to tailor the gas to specific applications. The gas used to generate the plasma is distinct from the radiation curable monomer. This may provide a more controllable and practicable method compared to generating a plasma using the monomer itself, due to the quantities involved. For example, the ‘high’ flow rates, such as 25 ml per minute, used in embodiments of the invention would cause considerable vacuum problems if ionised in a plasma.

One or more further gases may be added to the primary gas used to create the plasma, the further gas(es) being arranged to perform one or more additional functions such as removing unwanted species from the web, or including certain species in the developing polymer film on the web substrate. The use of an ion flux as the primary curing initiator has a further advantage over the use of an electron flux in that the ion flux may contain ionised species from both the primary plasma gas and the further plasma gas, meaning that, even with the plasma spaced from the web substrate, the further gas can act upon the web or polymer film though migration of its ions. In one example, hydrogen could be used to passivate the surface. In another example, nitrogen could be introduced as the further gas in order to introduce a reactive bonding species aimed at increasing or changing the crosslinking within the film.

The moving substrate is exposed to the ion flux for a period of time inversely proportional to the web speed. This period of time shall be referred to as the ‘dwell time’ and this can be influenced by the web speed and the length of web being exposed to the flux, which shall be referred to as the ‘dwell length’. It is preferred that the dwell length be as short as is reasonably practicable. A unit power dose measured in W/cm² experienced by the web can be calculated by dividing the operating power of the plasma generator by the cross sectional area of the ion flux. The unit power dose can be used with the dwell time to establish a unit energy dose on the web, measured in J/cm². With a known flow rate of radiation curable precursor and width of delivery the energy dose per unit precursor can be attained.

The plasma generator used in embodiments of the present invention may be connected to an AC or a DC power supply. Depending on the power supply used, it is possible to create and control an ion flux having the stated energy ranges, such as an energy level that is no greater than 250 eV or an energy level that is no greater than 100 eV. For example, the voltage applied to the plasma generator may define the maximum energy level and as such applying 250V results in an ion flux having a maximum energy level of 250 eV. Higher voltages can be used.

In embodiments of the invention it is preferred that the unit energy dose, described above, is no greater than 15 J/cm², more preferably no greater than 13 J/cm², and in some embodiments the unit power may be no greater than 0.1 J/cm². It is preferred that the dwell length, as described above is between 5-50 cm and even more preferred to be 10 cm. A short flux may undesirably limit the line speed of the web, whereas a long flux length may lead to undesirably high power consumption and impracticability of space. It is preferred that the dwell time be as low as possible whilst still giving full cure to ensure a high process efficiency.

The substrate can optionally be pre-coated or post-coated, vacuum deposited or printed with a wide variety of metals, metallic or non-metallic compounds and other materials, in order to achieve desired properties or effects. For non-transparent barrier applications, for example, substrates such as polyester films coated with a metal such as aluminium are especially preferred. For transparent barrier applications, substrates such as polyester films coated with a transparent metallic or non-metallic oxide, nitride or other compound (e.g. oxide of aluminium or oxide of silicon) are especially preferred. For electrical or electronic applications, the web substrate may be optionally pre-coated with a metal such as copper or another conductive inorganic or organic material, which however may be transparent or non-transparent. However, the invention is not limited to these specified coatings.

For very high barrier applications, a plurality of barrier layers, separated by polymer layers, is used, as this extends the diffusion pathway for gas or vapour between the permeable defects in each barrier layer. In this case, since the polymer layer is functioning as a separating layer between two metal or ceramic layers, and has little or no inherent barrier of its own, it should preferably be as thin as practicable, conducive with the requirements that it should be continuous, i.e. with no voids or defects, and have good surface smoothness to maximise the barrier of the second or subsequent barrier layer.

For optically variable devices, the function of the polymer layer is to generate light interference, and thus produce a “colour shift”. For such applications, a coating thickness of approximately a quarter to half of the wavelength of the incident light is preferred but the invention is not limited by this thickness.

Materials manufactured by the invention are suitable for use in multiple different applications including: packaging applications; abrasion-resistant material or intermediate (in which the polymer coating prevents abrasion damage to any underlying functional layers during conversion or use); security or anti-counterfeit applications, including continuously optically variable devices; decorative applications, including continuously optically variable devices; functional industrial applications; and electrical or electronic applications (inclusive of static electricity dissipation).

1. A composition for in vacuo coating of a substrate, the composition comprising:
at least 50% by weight of the composition an acrylate monomer or an oligomer formed from the acrylate monomer, the acrylate monomer having the formula H2C═CHCO2CH2CH(OH)R, where R is an optionally substituted alkyl, alkenyl, aryl, or heteroaryl; and
0.5 to 15% by weight an adhesion promoter,
wherein the adhesion promoter comprises an acid modified methacrylate.

2. A composition according to claim 1, wherein the acid modified methacrylate is 2-hydroxyethyl methacrylate phosphate.

3. A composition according to claim 1, wherein the adhesion promoter comprises at least 95% acid modified methacrylate.

4. A composition according to claim 1, wherein the adhesion promoter comprises 45 to 95% by weight acid modified methacrylate, and 5 to 55% by weight ethoxylated ester of acrylic acid or phosphoric acid.

5. A composition according to claim 1, which is suitable for deposition by flash vaporisation at up to 300° C.

6. A composition according to claim 1, wherein the composition can be cured using a plasma, ion beam or UV.

7. Use of a composition according to claim 1 for in vacuo coating of a substrate.

8. A method of coating a substrate in vacuo, the method comprising the steps of:
providing a composition, the composition comprising: at least 50% by weight an acrylate monomer or an oligomer formed from the acrylate monomer, the acrylate monomer having the formula H2C═CHCO2CH2CH(OH)R, where R is an optionally substituted alkyl, alkenyl, aryl, or heteroaryl; and 0.5 to 15% by weight an adhesion promoter, wherein the adhesion promoter comprises an acid modified methacrylate;
depositing the composition onto the substrate in vacuo; and
curing the composition.

9. A method according to claim 8, wherein the substrate is a polymer web, optionally wherein the polymer web is coated with an inorganic barrier layer.

10. A method according to claim 9, wherein the inorganic barrier layer comprises a metal.

11. A method according to claim 10, wherein the inorganic barrier layer comprises an oxide.

12. A film comprising a substrate which is coated on at least one surface with a polymeric coating, wherein the polymeric coating is a cured composition according to claim 1.
